(19) United States
(12) Patent Application Publication
(10) Pub. No.: US 2014/0106941 A1
(43) Pub. Date: Apr. 17, 2014

(54) SELF-OPERATING BACK STRETCHING DEVICE

(71) Applicants: Joseph W. Evans, Houston, TX (US); Robert G. Gottlieb, Houston, TX (US)

(72) Inventors: Joseph W. Evans, Houston, TX (US); Robert G. Gottlieb, Houston, TX (US)

(21) Appl. No.: 13/651,712

(22) Filed: Oct. 15, 2012

(51) Int. Cl. A61H 1/02

(52) U.S. Cl. CPC A61H 1/0237
USPC 482/91

(57) ABSTRACT

A manually operated back stretching device for relieving compressive forces of the lower lumbar vertebrae and safely stretching lower back muscles includes a platform that supports a user's lower legs. As the user moves a portion of the device with their arms toward their legs, the forward edge of the platform rises up and tilts away from the user's torso, causing the user's hips to lift off the floor and simultaneously stretching the user's back. As the user moves their arms back over their head, the user's back and legs relax while the arms are pulled above the user's head. The result may be a back-and-forth dynamic rotational arching motion that repetitively raises the relaxed hips and tilts them forward to decompress the spine using appropriate longitudinal and torsion forces at the most pain causing compression points of the lower lumbar vertebrae.

### CROSS-REFERENCE TO RELATED APPLICATION

This application is a Continuation-In-Part of, and claims priority of, U.S. patent application Ser. No. 12/838,730, filed on Jul. 19, 2010.

The present invention relates to body stretching devices and, more particularly, to a self-operating device for stretching a user's back.

Current methods for stretching a person's back use traction devices, such as those used at a chiropractor's office, to relieve compressive forces. These devices require the user to lie on a relatively flat surface in which a hip harness applies non-dynamic longitudinal forces without the use of torsion forces. This can be quite painful and difficult to tolerate. Since the spine is curved, pulling on a curved weight bearing structure requires extra longitudinal tension force to accomplish the same result as a combined longitudinal and torsion force application using simple leverage and the body's own weight.

U.S. Pat. No. 6,443,916 uses elliptical vertical motion to raise the hip and tilt it forward. The motion's amplitude and frequency cannot be controlled by the user. In addition, the device of the '916 patent requires electricity for operation.

As can be seen, there is a need for a device, for which the user may have control that may stretch a user's back.

### SUMMARY OF THE INVENTION

In one aspect of the present invention, a device comprises a platform attached to a first end of first and second adjustable extension arms;
a first and second adjustable fulcrum leg extending from the first end of the first and second extension arms, respectively;
a rearward adjustable extension arm is attached to the platform;
a vertically adjustable component is attached to the end of the rearward directed extension arm;
a foot restraint bar is attached to the second end of the vertically adjustable component;
a first and second foot pad encase the foot restraint bar on each side of the attachment point between the vertically adjustable component and the foot restraint bar;
a structure support plate is attached to the first and second vertical fulcrum legs;
the first end of a third and fourth extension arm pivotally attached to the second end of the first and second fulcrum legs, respectfully;
a rearward cross piece connecting the third and fourth extension arms;
the first end of a first and second lever arm pivotally attached to the second end of the third and fourth extension arms, respectfully;
a first and second adjustable hinge fitting attached to the first and second lever arm;
a fifth and sixth adjustable extension arm attached to the second end of the first and second adjustable hinge fitting, respectfully;
the second end of a fifth and sixth adjustable lever arm 90 pivotally attached to the second end of the first and second lever arms, respectfully;
the second end of a third and fourth adjustable lever arm pivotally attached to the second end of the first and second extension arms;
the first and second hand grips are attached to the second end of the first and second lever arms;

These and other features, aspects and advantages of the present invention will become better understood with reference to the following drawings, description and claims.

### BRIEF DESCRIPTION OF THE DRAWINGS

FIG. 1 shows a perspective view of a stretching device according to the current embodiment of the present invention.

### DETAILED DESCRIPTION OF THE INVENTION

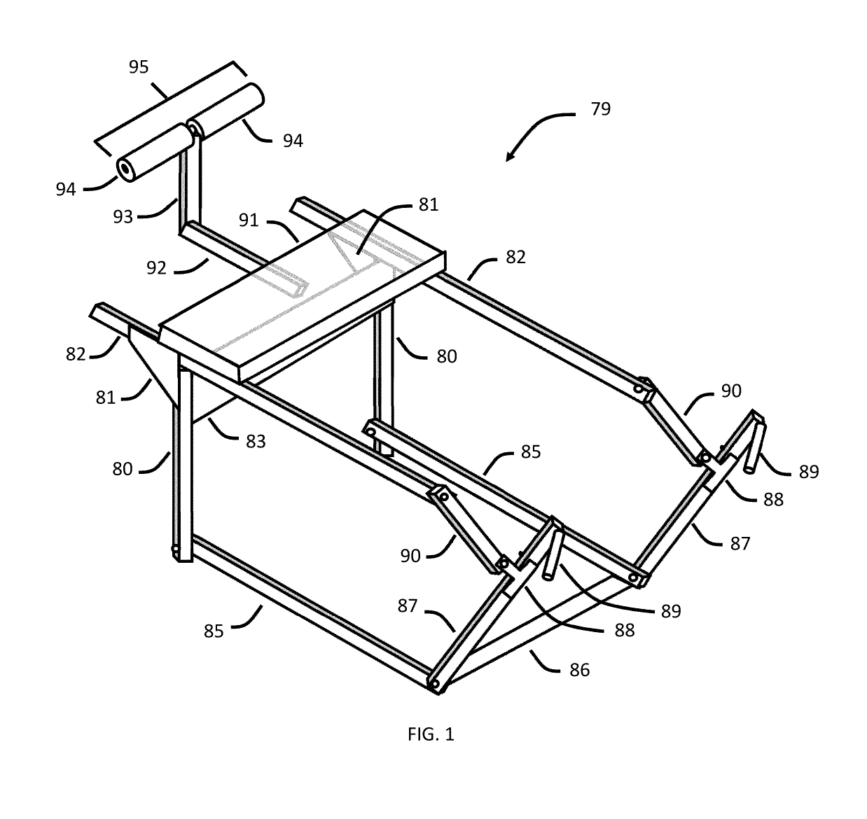

As shown in FIG. 1, a stretching device 79 may include a platform 91 attached near a first end of first and second extension arms 82. First and second vertical fulcrum legs 80 may be attached, extending below the platform 91, to first and second extension arms 82 form approximately 90 degree angles there between. A bracket 81 may be used for joining the fulcrum legs 80 to the extension arms 82. The fulcrum legs 80 may be height adjustable by known means.

A rearward adjustable extension arm 92 is attached to the platform 91. A vertically adjustable component 93 is attached to the end of the rearward directed extension arm 92. A foot restraint bar 95 is attached to the second end of the vertically adjustable component 93. Foot pads 94 encase the foot restraint bar 95 on each side of the attachment point between the vertically adjustable component 94 and the foot restraint bar 95.

A structure support plate 83 is attached to the first and second vertical fulcrum legs 80. A third and fourth extension arm 85 are pivotally attached to the second end of the first and second fulcrum legs 80. A rearward cross piece 86 connecting the third and fourth extension arms 85.

The first end of a first and second lever arm 87 pivotally attached to the second end of the third and fourth extension arms 85, respectfully. A first and second adjustable hinge fitting 88 attached to the first and second lever arms 87. A fifth and sixth adjustable extension arm 90 attached to the second end of the first and second adjustable hinge fitting 88, respectfully. The second end of a fifth and sixth adjustable lever arm 90 pivotally attached to the second end of the first and second lever arms 82, respectfully. The second end of a third and fourth adjustable lever arm pivotally attached to the second end of the first and second extension arms. The first and second hand grips 89 are attached to the second end of the first and second lever arms 87.

1. A device comprising:
a platform attached to a first end of first and second adjustable extension arms;
a first and second adjustable fulcrum leg extending from the first end of the first and second extension arms, respectively;
a rearward adjustable extension arm is attached to the platform;
a vertically adjustable component is attached to the end of the rearward directed extension arm;
a foot restraint bar is attached to the second end of the vertically adjustable component;
a first and second foot pad encase the foot restraint bar on each side of the attachment point between the vertically adjustable component and the foot restraint bar;
a structure support plate is attached to the first and second vertical fulcrum legs;
the first end of a third and fourth extension arm pivotally attached to the second end of the first and second fulcrum legs, respectfully;
a rearward cross piece connecting the third and fourth extension arms;
the first end of a first and second lever arm pivotally attached to the second end of the third and fourth extension arms, respectfully;
a first and second adjustable hinge fitting attached to the first and second lever arm;
a fifth and sixth adjustable extension arm attached to the second end of the first and second adjustable hinge fitting, respectfully;
the second end of a fifth and sixth adjustable lever arm 90 pivotally attached to the second end of the first and second lever arms, respectfully;
the second end of a third and fourth adjustable lever arm pivotally attached to the second end of the first and second extension arms;
the first and second hand grips are attached to the second end of the first and second lever arms.
